(19) United States
(12) Patent Application Publication
(10) Pub. No.: US 2026/0064517 A1
(43) Pub. Date: Mar. 5, 2026

(54) LOG-BASED PROCESS PROGRESS AND ERROR DIAGNOSTICS

(71) Applicant: Ivanti, Inc., South Jordan, UT (US)

(72) Inventor: Paul Keith Branton, Daresbury (GB)

(73) Assignee: Ivanti, Inc., South Jordan, UT (US)

(21) Appl. No.: 19/319,689

(22) Filed: Sep. 4, 2025

Related U.S. Application Data
(60) Provisional application No. 63/691,261, filed on Sep. 5, 2024.

(51) Int. Cl. G06F 11/07

(52) U.S. Cl. CPC G06F 11/079; G06F 11/0742

(57) ABSTRACT

An embodiment includes a method of process analysis that includes obtaining a preliminary log file. The preliminary log file is generated during implementation of a first process. The method includes identifying a first token associated with the first process in the preliminary log file. The method includes calculating an expected number of the first token in the preliminary log file. The method includes identifying a number of times the first token is present in the preliminary log file. The method includes determining a progress indicator of the first process based on a comparison between the expected number of the first token in the preliminary log file and the number of times the first token is present in the preliminary log file.

### CROSS-REFERENCE TO RELATED APPLICATION

This application claims the benefit of and priority to U.S. Provisional Application No. 63/691,261, filed Sep. 5, 2024, which is incorporated herein by reference in its entirety.

### FIELD

The embodiments described in this disclosure are related to mobile device management (MDM) processes, and more particularly to systems and methods of monitoring progress of processes performed with respect to mobile devices.

### BACKGROUND

In some endpoints and device management solutions, large-scale processes may be implemented remotely. For instance, certain mobile device management (MDM) operations may be performed and/or initiated by the MDM administrator and/or organizations with respect to mobile devices. For example, large-scale processes may include product security scan (e.g., ensuring that mobile devices comply with security policies), product update (e.g., new features, security patches, performance improvements, compatibility enhancements, etc.), and/or application install may be implemented remotely.

During such processes, the user and the administrator do not have clear visibility into the progress. For example, the user and/or the administrator may not be able to monitor the progress of the processes. The progress information is generally available in the log file. However, the information exists within a larger file and for only a short amount of time, which makes manual monitoring difficult. Furthermore, it is difficult for the management service to provide an indication of the progress through conventional means because the processes are often controlled by a third party, which obfuscates much of the data involved in progress calculations. For instance, the service provider may not know backend processes that are outside control of managed portion of the network such as file sizes, bandwidth allocations at a source, and the like.

Accordingly, there is a need in the field of MDM systems that enables monitoring of progress of such processes. Such progress information may help improve administrative efficiency and evaluation of different processes. For example, the progress information may be useful in identifying errors and/or delays, analyzing efficiency of the processes, and/or improving the processes, among others.

The subject matter claimed herein is not limited to embodiments that solve any disadvantages or that operate only in environments such as those described. Rather, this background is only provided to illustrate one example technology area where some embodiments described herein may be practiced.

### SUMMARY

According to an aspect of an embodiment includes a method of process analysis. The method may include obtaining a preliminary log file, in which the preliminary log file is generated during implementation of a first process. The method may include identifying a first token associated with the first process in the preliminary log file. In some embodiments, the first token may include one or more of a short bit of text or an icon. Additionally or alternatively, the first token may represent a block including a plurality of log lines. The method may include calculating an expected number of the first token in the preliminary log file. In some instances, in which the first token represents a block, calculating the expected number of the first token may include identifying a size of the preliminary log file; identifying a block size of the block; and determining a number of blocks, corresponding to the expected number of the first token, based on the size of the preliminary log and the block size of the block. The method may further include identifying a number of times the first token is present in the preliminary log file. The method may include determining a progress indicator of the first process based on a comparison between the expected number of the first token in the preliminary log file and the number of times the first token is present in the preliminary log file. The method may further include determining that the first process failed to complete based on the progress; determining that an error has occurred with respect to the first process; and identifying location of the error. In some embodiments, one or more lines having the error with respect to the first process may be identified, and a list of the one or more lines may be generated.

An additional aspect of an embodiment includes a non-transitory computer-readable medium having encoded therein programming code executable by one or more processors to perform or control performance at least a portion of the method described above.

Yet another aspect of an embodiment includes a computer device. The computer device may include one or more processors and a non-transitory computer-readable medium. The non-transitory computer-readable medium has encoded therein programming code executable by the one or more processors to perform or control performance of one or more of the operations of the methods described above.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a block diagram of an example operating environment in which some embodiments described in the present disclosure may be implemented;

FIG. 2 is a block diagram of a process monitoring process that may be implemented in the operating environment of FIG. 1;

FIG. 3 is example code which may be implemented in the progress of FIG. 2;

FIG. 4 is a block diagram of an example MDM endpoint user interface that may be implemented in the process of FIG. 2;

FIG. 5 illustrates an example computer system configured for process analysis;

FIG. 6 is a flow chart of an example method of process analysis;

FIGS. 7A-7E are an example truncated log that may be monitored in the process of FIG. 2; and

FIGS. 8A-8C are another example, truncated log that may be monitored in the process of FIG. 2, all according to at least one embodiment described in the present disclosure.

### DESCRIPTION OF SOME EXAMPLE EMBODIMENTS

The embodiments described in this disclosure are directed to system and methods of monitoring and analyzing progress of large-scale processes based on log files generated during implementation of the processes. For instance, the processes may not be directly controlled by an endpoint device or a management device, which may restrict access to information indicative of progress of the processes. The restricted access to information may prevent visibility of the progress of the processes. Accordingly, users and administrators implementing the processes cannot ascertain a status of the processes (e.g., whether the processes are being implemented correctly, are stalled, have experienced an error, etc.).

The log files generated during the processes provide data from which embodiments of the present disclosure derive progression indicators. For example, downloading a third-party application by a device enrolled in a mobile device management (MDM) network or performing an application-update process on a device enrolled in an endpoint management network may be circumstances in which information indicative of progress is restricted. In these and other processes, a log file is generated as the processes is implemented. Some embodiments determine progress of the processes and enable error identification based on the log files. For instance, in some embodiments, an MDM administrator may remotely cause mobile devices within an MDM network to implement one or more processes such as downloading a third-party application or performing an application-update process. In these and other embodiments, a preliminary log file may be generated during implementation of the processes. The preliminary log file may represent actions and/or steps taken during the implementation of the processes. For example, the preliminary log files may represent start and end of the processes, intermediate steps, warning, and/or errors.

The preliminary log files may be analyzed based on a pattern matching approach. For example, a token associated with the process may be identified in the preliminary log file. The token may include data that may represent occurrence of a function and/or an operation such as a short bit of text, an icon, or a term (e.g., “scan”). The presence of the token in the preliminary log file may represent a presence of the block of log lines associated with the token. An expected number of the tokens in the preliminary log file may be calculated. For example, the expected number may be calculated based on a successful run of the process. In these and other embodiments, a number of times the token is present in the preliminary log file may be determined and compared to the expected number. The comparison may be used to determine a progress indicator which represents progress of the process and whether the process successfully ran.

These and other embodiments are described with reference to the appended Figures in which like item number indicates like function and structure unless described otherwise. The configurations of the present systems and methods, as generally described and illustrated in the Figures herein, may be arranged and designed in different configurations. Thus, the following detailed description of the Figures, is not intended to limit the scope of the systems and methods, as claimed, but is merely representative of example configurations of the systems and methods.

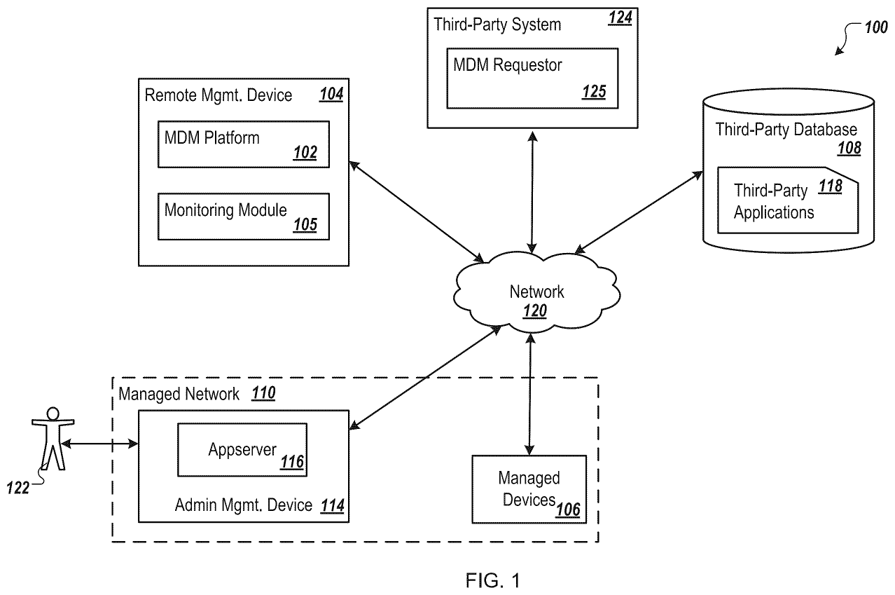

FIG. 1 is a block diagram of an example operating environment 100 in which some examples of the present disclosure can be implemented. The operating environment 100 may include a monitoring module 105 as part of a remote management device 104. The monitoring module 105 may be configured to monitor progress of one or more different processes (e.g., installs, updates, etc.) that are performed with respect to one or more managed devices 106 by a third-party system 124.

In the operating environment 100, an MDM platform 102 may facilitate communication between the managed devices 106 and the appserver 116. Particularly, the MDM platform 102 may help enforce security policies, manage applications, and/or monitor the status of the managed devices 106. In some embodiments, the portion of the managed devices 106 managed using the MDM platform 102 may be Apple™ or Mac™ computing systems or may implement Apple™ or Mac™ operating systems such as iOS, MacOS, etc.

Conventional MDM systems do not have a way of monitoring progress of applications being pushed onto the managed devices 106. For example, an update to an existing application or an installation of a new application may be requested by the MDM platform 102 to the third-party system 124 (e.g., the MacOS). The third-party system 124 may push the update and/or the installation to the managed device 106 based on third-party applications data 118 stored in a third-party database 108. In such instances, the conventional MDM systems do not have a way of monitoring the progress of the update and/or the installation as the process is performed by the third-party system using the third-party database 108. Instead, the conventional MDM systems only get a notification of completion or a failure when the update and/or the installation process finishes.

In the embodiment of FIG. 1, the operating environment 100 includes the MDM platform 102 and the managed devices 106 are managed at least partially by the MDM platform 102. In other embodiments, the managed devices 106 may not be enrolled in an MDM network and may not be managed by the MDM platform 102. In these and other embodiments, the monitoring and error diagnosis based on the log files may be implemented substantially as described herein. Throughout the present disclosure, the embodiments including the MDM platform 102 are described. However, embodiments of the present disclosure are not limited to MDM networks. Instead, the analysis of log files as described herein may be applied in other suitable environments in which information indicative of the progress of processes is restricted or otherwise unavailable.

Embodiments of the present disclosure provide a technical improvement to conventional MDM systems. Specifically, embodiments of the present disclosure implement a monitoring module, which is represented in FIG. 1 by the monitoring module 105. The monitoring module 105 may be configured to monitor updates and/or installations performed by the third-party system 124 based log files associated with the updates and/or installations. Particularly, the monitoring module 105 may determine a certain token within the log files and use the token to track progress of the processes. For example, an expected number of tokens may be determined based on a type of process being pushed. As the log file progresses, the instances of token may be identified and counted. The counted numbers of the token may be compared against the expected number of tokens to determine whether the process is progressing as expected. Additionally, the tokens may be used to identify timing and/or location of errors within the progress. For example, successful counts and/or identification of the tokens prior to detection or an error or a failed identification of an expected token may be used to determine a possible location and/or timing of the error.

Accordingly, examples of the present disclosure are directed to a computer-centric problem and are implemented in a computer-centric environment. For instance, the examples of the present disclosure are directed to MDM systems in the managed network 110. Communications during the processes described in this present disclosure involve the communication of data in electronic and optical forms via a network 120 and also involve the electrical and optical interpretation of the data and information.

The operating environment 100 may include a managed network 110, a third-party system 124, a third-party database 108, and a remote management device 104. The managed network 110 may include an admin management device 114 and the managed devices 106. The components of the operating environment 100 are configured to communicate data and information via the network 120 to perform generation and implementation of predicates as described in the present disclosure. Each of these components are introduced below.

The network 120 may include any communication network configured for communication of signals between the components (e.g., 104, 112, 108, 114, and 106) of the operating environment 100. The network 120 may be wired or wireless. The network 120 may have configurations including a star configuration, a token ring configuration, or another suitable configuration. Furthermore, the network 120 may include a local area network (LAN), a wide area network (WAN) (e.g., the Internet), and/or other interconnected data paths across which multiple devices may communicate. In some examples, the network 120 may include a peer-to-peer network. The network 120 may also be coupled to or include portions of a telecommunications network that may enable communication of data in a variety of different communication protocols.

In some examples, the network 120 includes or is configured to include a BLUETOOTH® communication network, a Z-Wave® communication network, an Insteon® communication network, an EnOcean® communication network, a Wi-Fi communication network, a ZigBee communication network, a representative state transfer application protocol interface (REST API) communication network, an extensible messaging and presence protocol (XMPP) communication network, a cellular communications network, any similar communication networks, or any combination thereof for sending and receiving data. The data communicated in the network 120 may include data communicated via short messaging service (SMS), multimedia messaging service (MMS), hypertext transfer protocol (HTTP), direct data connection, wireless application protocol (WAP), or any other protocol that may be implemented in the components of the operating environment 100.

The depicted example of the operating environment 100 includes the third-party system 124. The third-party system 124 may include a hardware-based server configured to communicate data and information with the other components of the operating environment 100 via the network 120. The third-party system 124 may be configured to support distribution of software or application updates and/or installations in the operating environment 100. For instance, after the MDM platform 102 determines that there is an existing update for an existing application and/or a new application needs to be installed at one or more of the managed devices 106, the MDM platform 102 may request to the third-party system 124 to process such installations. Particularly, the MDM platform 102 may send the request to an MDM requestor 125 of the third-party system 124. The MDM requestor 125 may be configured to communicate with the third-party system 124 to pull the updates and installations and to install at the managed devices 106.

The third-party system 124 may also communicate with the third-party database 108. For instance, the third-party system 124 may access the third-party application data 118 stored in the third-party database 108. For instance, the third-party application data 118 may provide the third-party system 124 with the data needed to install and/or update the applications on the managed devices 106. The third-party database 108 may include a non-transitory storage medium such as the memory 512 that is configured to communicate with one or more of the components of the operating environment 100 via the network 120. In some embodiments, the third-party database 108 may be incorporated in the third-party system 124.

The managed network 110 includes the admin management device 114 and the managed devices 106. The managed network 110 is implemented to enable management of the managed devices 106 by the remote management device 104. To implement the managed network 110, the managed devices 106 and the admin management device 114 may be enrolled. After the managed devices 106 and the admin management device 114 are enrolled, ongoing management of the managed devices 106 may be implemented by the remote management device 104 and the admin management device 114. The ongoing management may include overseeing and dictating at least a part of the operations at the managed devices 106 as well as dictate or control policies such as application policies, security policies, communication policies, etc. at the managed devices 106 as described in the present disclosure. The managed network 110 may be associated with an enterprise, a portion of an enterprise, a government entity, or another entity or set of devices. The managed network 110 may be an MDM network in which the managed devices 106 are managed.

The managed devices 106 may include hardware-based computer systems that are configured to communicate with the other components of the operating environment 100 via the network 120. The managed devices 106 may include any computer device that may be managed by the remote management device 104 and/or have been enrolled in the managed network 110. Generally, the managed devices 106 include devices that are operated by the personnel and systems of an enterprise or store and process data of the enterprise. The managed devices 106 might include workstations of an enterprise, servers, data storage systems, printers, telephones, internet of things (IOT) devices, smart watches, sensors, automobiles, battery charging devices, scanner devices, etc. The managed devices 106 may also include virtual machines, which may include a portion of a single processing unit or one or more portions of multiple processing units, which may be included in multiple machines.

The admin management device 114 may include a hardware-based computer system that is configured to communicate with the other components of the operating environment 100 via the network 120. The admin management device 114 is configured to at least partially administrate MDM in the managed network 110. For example, the admin management device 114 may include an application server interface (hereinafter, “appserver”) 116. The appserver 116 access the MDM platform 102 via the network 120. Accordingly, user interfaces and webpages that are hosted on the remote management device 104 may be displayed at the admin management device 114. Input received at the appserver 116 may be communicated to the MDM platform 102.

The admin management device 114 may be associated with the administrator 122. The administrator 122 may be an individual, a set of individuals, or a system that interfaces with the admin management device 114. In some examples, the administrator 122 may provide input to the admin management device 114. The input provided by the administrator 122 may form the basis of some computing processes performed by the admin management device 114 and the MDM platform 102. For example, the administrator 122 may provide user input to the appserver 116, which is used as input to the MDM platform 102. In some embodiments, the user input may include a natural language input entered in text or audibly. The user input may include text, code fragments, operators, etc. In addition, the user input may include mistakes.

In some embodiments, the admin management device 114 may include the MDM platform 102 and the monitoring module 105. In these and other embodiments, the process monitoring and the MDM may be performed as an “on prem” service. In these embodiments, the remote management device 104 may be omitted or may not implement processes and operations related to generation and implementation of the predicates. Instead, the admin management device 114 may implement these processes and operations.

In some embodiments, the admin management device 114 is one of or substantially similar to the managed devices 106. For instance, the admin management device 114 may be one of the managed devices 106 assigned to the administrator 122. Additionally, in some embodiments, the admin management device 114 may be omitted, and the administrator 122 may use one of the managed devices 106 to interface with the remote management device 104 remotely.

The remote management device 104 may include a hardware-based computer system that is configured to communicate with the other components of the operating environment 100 via the network 120. In some examples, the remote management device 104 may be a single server, a set of servers, a virtual device, or a virtual server in a cloud-base network of servers. In these and other examples, the MDM platform 102 and the monitoring module 105 may be spread over two or more cores, which may be virtualized across multiple physical machines.

The remote management device 104 may be configured for mobile device management (MDM) of the managed devices 106 in the managed network 110. In general, MDM of the managed devices 106 may include determining security polices, application policies, the security settings, network communication settings, etc. implemented at the managed devices 106. In some embodiments, the remote management device 104 may be configured to supply other management services unified endpoint management, service management (e.g., help desk and technical ticketing), patch or update management, application management, asset management, vulnerability detection, other management services, or combinations thereof.

In some embodiments, the remote management device 104 may include a monitoring module 105 configured to monitor progress logs of processes implemented on mobile devices (e.g., the managed devices 106).

In some embodiments, in instances an installation takes a place at the managed devices 106, the monitoring module 105 associated with the managed devices 106 may be configured to obtain preliminary log files associated with installation. For example, a first process (e.g., an installation of a new application) may be pushed onto the managed devices 106 from the third-party system 124. In such instances, the monitoring module 105 may obtain the preliminary log file generated during the implementation of the first process. In some embodiments, the monitoring module 105 may obtain the preliminary log files in real time. In some embodiments, the monitoring module 105 may obtain the preliminary log files from the third-party system 124 and/or the managed devices 106 at which the installations take place. For example, the monitoring module 105 may obtain the preliminary log files from operating system logs (e.g., system logs accessible via developer tools) and/or installer logs (e.g., installer programs such as Apple™ installer for macOS). The installer logs may generate logs that track the progress of software installations, and the monitoring module 105 may query such progress in real time.

The obtained preliminary log file may not provide status of the progress. For instance, the preliminary log file may merely include lines of codes that are running. In some embodiments, the monitoring module 105 may be configured to identify a first token associated with the first process in the preliminary log file. The first token may include a certain portion of the preliminary log file that may represent progress in the first process. For example, presence of the first token may indicate successful run of at least a portion of the first process.

In some embodiments, the monitoring module 105 may identify the first token based on a previous run of the process. For example, the first process may include the same installation and/or update process as a previous performed processes. In such instances, the monitoring module 105 may identify the first token from the previous processes. In some embodiments, the monitoring module 105 may obtain the identification of the first token from the party performing the installation (e.g., the third-party system 124). For example, the monitoring module 105 may obtain an expected log file representing a log file of a successful run of the first process.

The monitoring module 105 may calculate an expected number of the first token in the preliminary log file based on the expected log file and/or the previous processes. The expected number of the first token may represent a number of instances the first token needs to be present in the preliminary log file for the first process to be considered as having run successfully. The monitoring module 105 may identify a number of times the first token is in the preliminary log file as the first process is being implemented. For instance, the monitoring module 105 may count the numbers of instances of the first token. The monitoring module 105 may determine a progress indicator of the first process based on a comparison between the expected number of the first token in the preliminary log file and the number of times the first token is present in the preliminary log file. For example, the first process may have an expected log file having ten instances of the first token. The ten instances of the first token may be generally evenly distributed. In such instances, the progress indicator may move in increments of 10% each time the first token is identified.

The monitoring module 105 may be implemented using hardware including a processor, a microprocessor (e.g., to perform or control performance of one or more operations), a field-programmable gate array (FPGA), or an application-specific integrated circuit (ASIC). In some other instances, the monitoring module 105 may be implemented using a combination of hardware and software. Implementation in software may include rapid activation and deactivation of one or more transistors or transistor elements such as may be included in hardware of a computing system (e.g., the managed devices 106 or the remote management device 104 of FIG. 1). Additionally, software defined instructions may operate on information within transistor elements. Implementation of software instructions may at least temporarily reconfigure electronic pathways and transform computing hardware.

Modifications, additions, or omissions may be made to the operating environment 100 without departing from the scope of the present disclosure. For example, the operating environment 100 may include one or more managed networks 110, one or more remote management devices 104, one or more managed devices 106, or any combination thereof. Moreover, the separation of various components and devices in the embodiments described herein is not meant to indicate that the separation occurs in all embodiments. Moreover, it may be understood with the benefit of this disclosure that the described components and servers may generally be integrated together into a single component or server or separated into multiple components or servers.

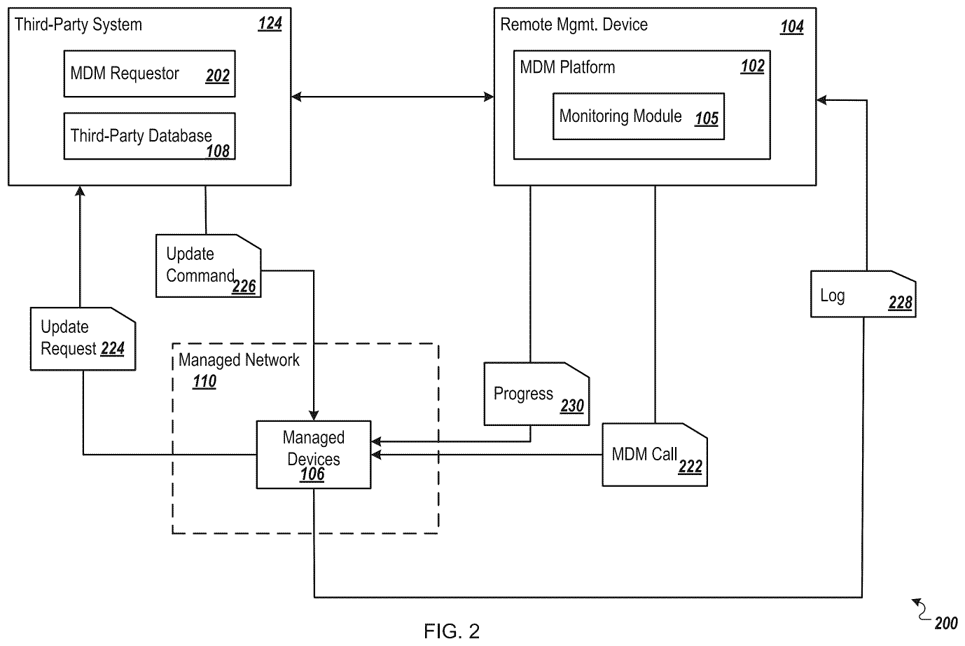

FIG. 2 is a block diagram of a process monitoring process 200 (process) that may be implemented in the operating environment 100 of FIG. 1 or another suitable operating environment. The process 200 may be implemented in the managed network 110 or another network that includes the MDM platform 102. FIG. 2 may include one or more components (e.g., the remote management device 104, the managed devices 106, and the third-party system 124, etc.) described with reference to FIG. 1. Although not depicted in FIG. 1, data may be communicated via communication network such as the network 120 of FIG. 1.

The process 200 may be implemented to monitor progress of application installations and/or updates on the managed devices 106. As described with reference to FIG. 1, at least a portion of the managed devices 106 may be Apple or Mac devices. Accordingly, the MDM platform 102 and the monitoring module 105 may be configured for Apple or Mac devices.

The process 200 may begin with the MDM platform 102 determining and/or obtaining a request for an update such as an operating system update. The MDM platform 102 may request an MDM call 222 to the managed devices 106 subject to the OS update. The MDM call 222 may be a specific communication initiated between the managed device 106 and the MDM server or the MDM platform 102. Generally, the managed devices 106 may request calls to the MDM platform 102 to check for updates. However, the MDM platform 102 may prompt the managed device 106 to initiate the MDM call 222 when an action, such as the update, is required.

The managed device 106 may send an update request 224 to the third-party system. Particularly, the managed device 106 may send the update request 224 to the MDM requestor 125 of the third-party system 124. In some embodiments, the MDM requestor 125 may be integrated as part of the third-party system 124.

The MDM requestor 125 may send an update command 226 to the managed device 106. In response to the obtaining the update command 226, the managed device 106 may perform the update. In some embodiments, the update command 226 may include data required for the update from the third-party database 108. While FIG. 2 illustrates the third-party database 108 as being part of the third-party system 124, the third-party database 108 may be separate from the third-party system 124, such as illustrated in FIG. 1.

As the update is being installed at the managed device 106, the managed device 106 may communicate a log 228 to the MDM platform 102, and particularly the monitoring module 105. In some embodiments, the log 228 may be communicated to the monitoring module 105 in real-time as the log 228 is updated during the process 200. For instance, the monitoring module 105 may view the log 228 as the managed device 106 is generating the log 228. In some embodiments, the log 228 may be generated by installer programs such as Apple™ installer for macOS. The monitoring module 105 may identify a token associated with the process (e.g., the update). The token may include a part of the log 228 that may be used to track progress of the log 228 and/or the process associated with the log 228. In some embodiments, the token may include one or more of a short bit of text or an icon. For example, the token may be “ENU”, “FRA”, “DEU”, among others. As another example, the token may be fixed strings such as “Network,” “USB,” “Storage,” among others. In some embodiments, the token may represent a block including multiple log lines. For example, the block may include the multiple log lines associated with a particular task or operation that is part of the process. In such instances, a number of blocks present in the log 228 may be determined based on a size of the log 228 and a block size of the block.

For example, the block size may represent a number of expected log lines in each block that begins or is otherwise detectable based on the token. The block size may be 100 log lines and the log 228 may include 800 log lines in this example. Accordingly, the log 228 may include or at least be expected to include eight instances of the token, which may occur in the log 228 every one hundred log lines.

In some embodiments, the token may include multiple parts or sections. For example, in instances in which the token includes a log line or multiple log lines, the token may have a prefix, contents, and a suffix. For example, the token may start with the prefix, contain the contents, and end with the suffix. In these and other embodiments, presence of one of the prefix, the contents, or the suffix may represent presence of the token.

In some embodiments, the monitoring module 105 may calculate an expected number of the token in the log 228. For example, the monitoring module 105 may determine how many times the token needs to be present in the log 228 for the log 228 to be considered successful. In some embodiments, the monitoring module 105 may determine the expected number of the token based on a successful run of the installation or the update. For example, the installation may have been performed successfully on another managed device. A number of times the token is present in the successful log may represent the expected number of tokens in the log 228. In instances in which no previous runs exist, the log 228 may be obtained without monitoring the status, such that a successful log may be obtained for future references. Additionally or alternatively, the monitoring module 105 may obtain the expected successful log from the third-party system 124. For example, the third-party system may have a log file that is expected from running the particular installation. The monitoring module 105 may obtain the expected log file and calculate the expected number of tokens in the log 228 based on the expected log file.

As the log 228 progresses, the monitoring module 105 may identify a number of times the token is present in the log 228. For instance, the monitoring module 105 may keep a count of how many times the token is present in the log 228. Based on a comparison between the expected number of the token in the log 228 and the number of times the token is present, the monitoring module 105 may determine a progress 230 of the process. For example, the expected number of the token may be 100 times. For instance, the log 228 may be considered complete in response to the token being present 100 times. In such instances, as the token is identified in the log 228, the monitoring module 105 may deduct from the expected number of tokens. For example, in response to detecting a first presence of the token, the expected number may drop to 99. In these and other embodiments, the progress 230 may represent such reduction in the expected number. For example, following the first presence of the token, the progress 230 may indicate 1% (e.g., 1/100) completion of the process.

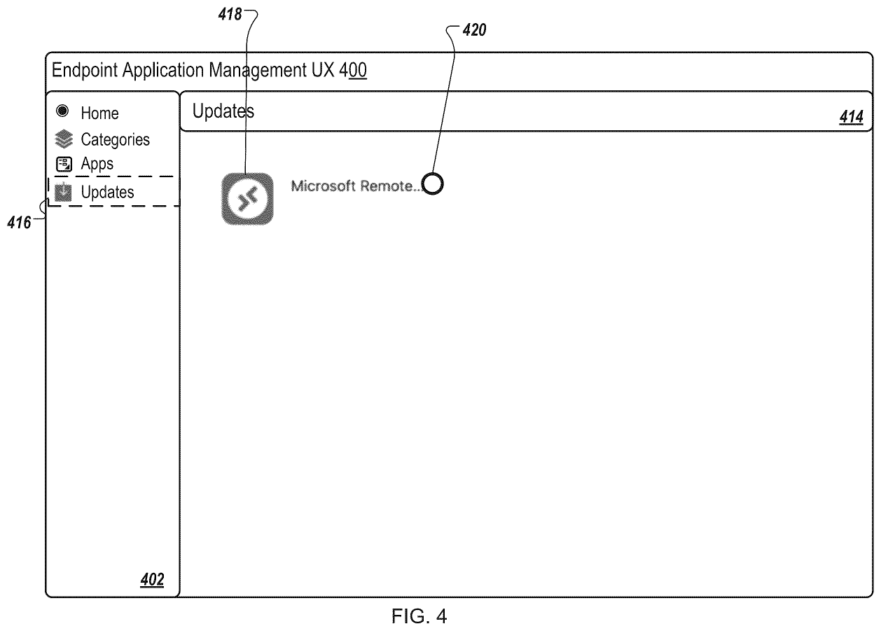

In some embodiments, the monitoring module 105 may present the progress 230 as a progress indicator on the managed device 106 such that user of the managed device 106 may view the progress 230. For example, FIG. 4 illustrates an example MDM endpoint user interface 400 that may include a progress indicator 420.

In some embodiments, the monitoring module 105 may be configured to determine that the process failed to complete. For example, the monitoring module 105 may determine the failure of the process based on the comparison between the expected number of tokens in the log and the identified number of the token. For example, the token may be present only 55 times in the log 228 when 100 instances of the token are expected. The monitoring module 105 may determine that an error has occurred with respect to the process based on the deficiencies between the expected and identified number of the token in the log 228. In some embodiments, the monitoring module 105 may be configured to determine a location of the error. For example, in instance in which the token was present 55 times out of 100, the error may be located between the location of the 55th token and expected location of the 56th token within the log 228. In some embodiments, the monitoring module 105 may further identify one or more lines in the log 228 including the error. For example, the monitoring module 105 may identify one or more lines that ended unsuccessfully and/or include an error message. In instances in which the monitoring module 105 is unable to identify specific location of the error, one or more lines between the successful token (e.g., the 55th token) and the unsuccessful token (e.g., the 56th token) may be identified as the one or more lines having the error.

In some embodiments, in response to identifying the error, the monitoring module 105 and/or the MDM platform 102 may request a reinstallation to the MDM requestor 125 or cause the managed device 106 to resend the update request 224 to the MDM requestor 125. In some embodiments, the monitoring module 105 may generate a list of the one or more lines including the error. In some embodiments, the list may be provided to the third-party system 124 implementing the installation such that the error may be identified and fixed. In some embodiments, the error may be caused due to an issue at the managed device 106. In such instances, the third-party system 124 may provide a message explaining the error.

In response to determining that the number of times the token is present in the log 228 matches the expected number of the token, the monitoring module 105 may reset a status of the process as completed. In some embodiments, the monitoring module 105 may further record the duration or processing time of the process.

In some embodiments, the processing time may be determined based on a start time and a stop time. In some embodiments, the start time may correspond to a time the monitoring module 105 first obtains the log 228. In other embodiments, the start time may correspond to a time the monitoring module 105 first identifies the token in the log 228. In some embodiments, the stop time may correspond to a time the monitoring module 105 identifies the last token (e.g., 100th token out of 100) in the log 228. The processing time may be the time between the start time and the stop time. In some embodiments, the processing time may be compared with an expected processing time of the process. The expected processing time may be determined based on prior runs of the process and/or be obtained from the third-party system 124. In instances in which a big gap exists between the processing time and the expected processing time, such gap may be notified to the third-party system 124 and/or the remote management device 104. In these and other embodiments, a gap may be considered as a big gap based on a time threshold. For example, the time threshold may specify that the gap between the processing time and the expected processing time that is above 50% of the expected time may be considered a big gap.

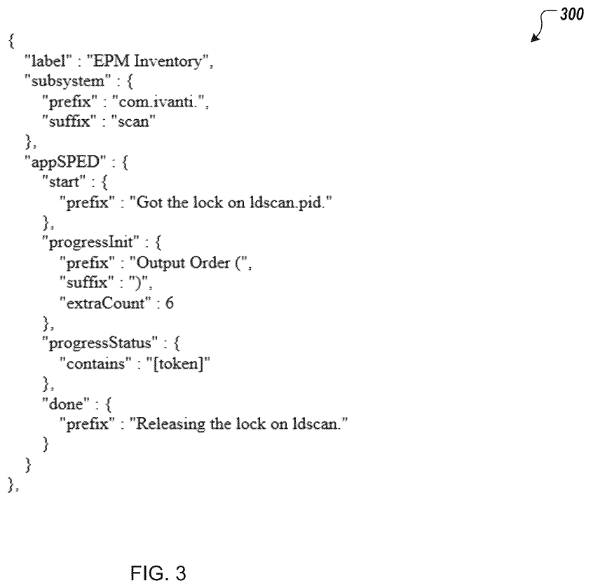

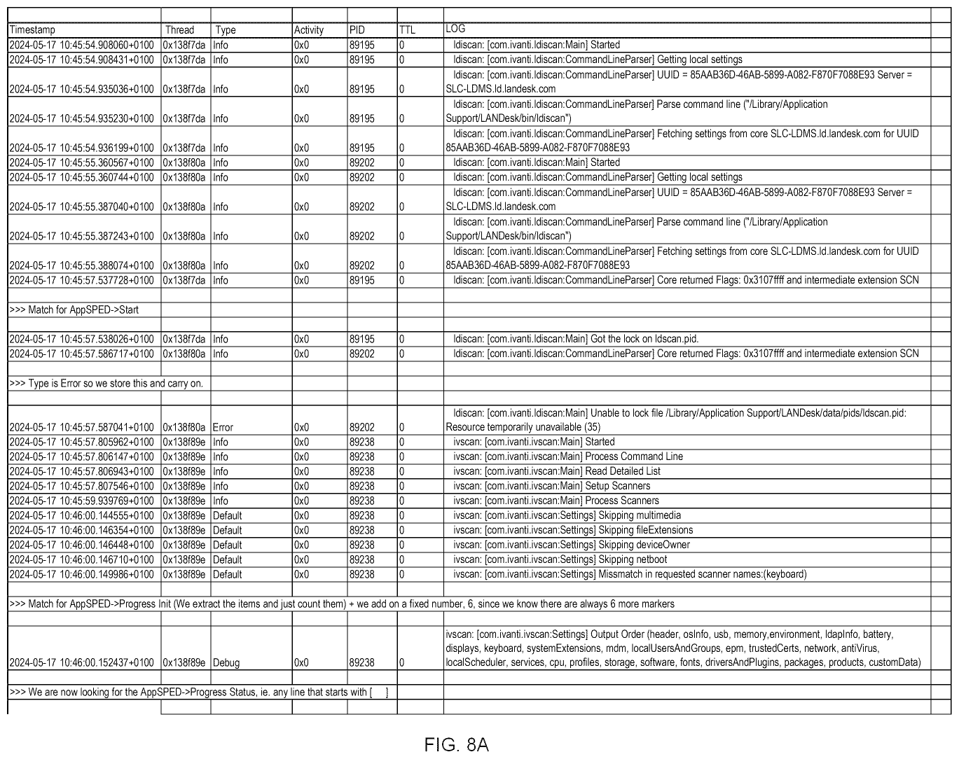

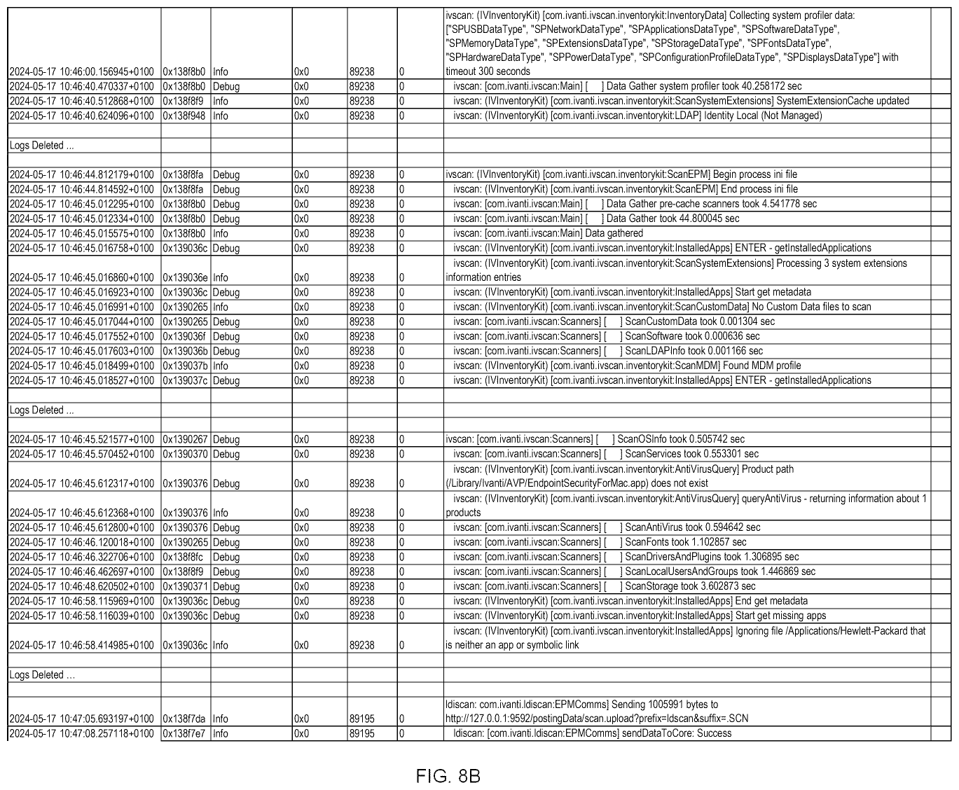

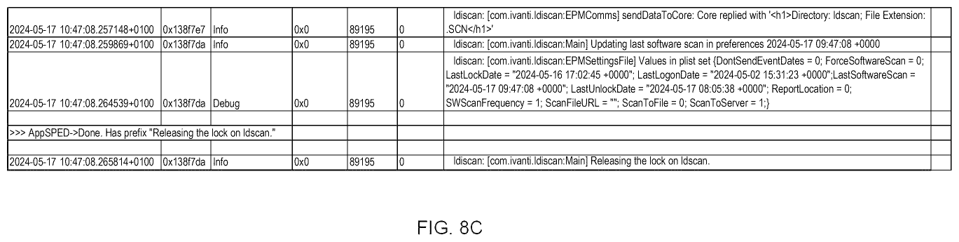

FIG. 3 illustrates example code 300 implementing operations of a monitoring process, such as implemented by the monitoring module 105 of FIGS. 1 and 2. For example, the monitoring module 105 may be configured to run the code 300 to monitor the progress of process “EPM Inventory.” The monitoring module 105 may monitor the progress of the process based on the tokens included in the code 300. For instance, the monitoring module 105 may run the code 300 with respect to log (e.g., the log 228 of FIG. 2 or a truncated log of FIGS. 8A-8C) of the process to track progress of the process. For example, the process may be considered as starting when the prefix “Got the lock on ldscan.pid” is found in the log. The monitoring module 105 may count the instances of the “[Token]” (in FIGS. 8A-8C a clock icon [@]) in the log to track progress of the process. The “[Token]” may include any types of tokens discussed with respect to FIG. 2 of the present disclosure.

FIG. 4 is a block diagram of an example MDM endpoint UX 400 that may be implemented in the process 200 of FIG. 2. The MDM endpoint UX 400 may be configured to present and/or display progress of an installation or an update to user of the managed devices (e.g., the managed devices 106 of FIG. 1).

The MDM endpoint UX 400 may include a first portion 402. The first portion 402 may enable selection of one or more functions of an MDM service. In these and other embodiments, the first portion 402 may include a updates tab which is generally indicated by dashed box 416. Selection of the updates tab 416 opens and updates window 414, which allows a user and/or an administrator to initiate and/or monitor progress of updates to different applications. For instance, as depicted, the updates window 414 may show a first application 418 that is going through an update. For instance, an MDM platform (e.g., the MDM platform 102 of FIG. 1) may have initiated the update of the first application 418 for the managed device through the third-party system. The progress of the update for the first application may be indicated using a first progress indicator 420.

In some embodiments, a monitoring module (e.g., the monitoring module 105 of FIG. 2) may generate the progress indicator 420. For example, the monitoring module may generate the progress indicator 420 based on the process 200 of FIG. 2. The progress indicator 420, as depicted, may illustrate a circular shape in which the circular shape is gradually filled out as the process progresses. While depicted using the circular shape, the progress indicator 420 may include any other suitable indicators such as a bar, a number, a percentage, and/or expected time for completion, among others.

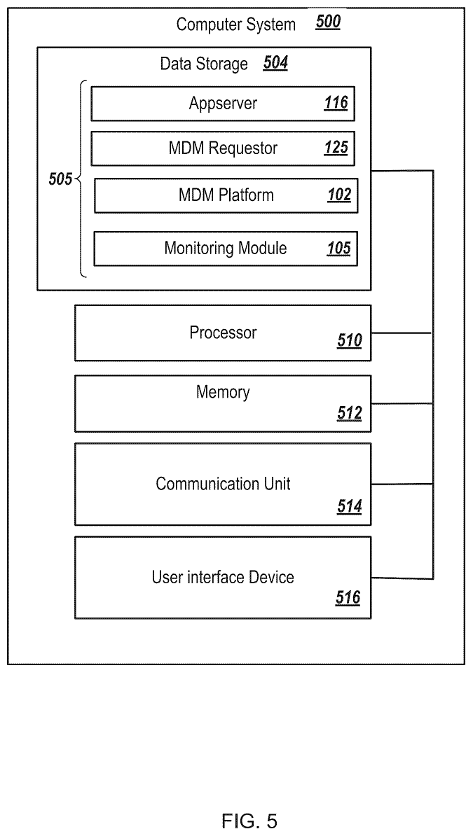

FIG. 5 illustrates an example computer system 500 configured for monitoring progress of processes, according to at least one embodiment of the present disclosure. The computer system 500 may be implemented in the operating environment 100 FIG. 1, for instance. Examples of the computer system 500 may include the remote management device 104, one or more of the managed devices 106, an edge device, or some combination thereof. The computer system 500 may include one or more processors 510, a memory 512, a communication unit 514, a user interface device 516, and a data storage 504 that includes one or more or a combination of the MDM platform 102, the appserver 116, the MDM requestor 125, and the monitoring module 105 (collectively, system modules 505).

The processor 510 may include any suitable special-purpose or general-purpose computer, computing entity, or processing device including various computer hardware or software modules and may be configured to execute instructions stored on any applicable computer-readable storage media. For example, the processor 510 may include a microprocessor, a microcontroller, a digital signal processor (DSP), an ASIC, an FPGA, or any other digital or analog circuitry configured to interpret and/or to execute program instructions and/or to process data. Although illustrated as a single processor in FIG. 5, the processor 510 may more generally include any number of processors configured to perform individually or collectively any number of operations described in the present disclosure. Additionally, one or more of the processors 510 may be present on one or more different electronic devices or computing systems. In some embodiments, the processor 510 may interpret and/or execute program instructions and/or process data stored in the memory 512, the data storage 504, or the memory 512 and the data storage 504. In some embodiments, the processor 510 may fetch program instructions from the data storage 504 and load the program instructions in the memory 512. After the program instructions are loaded into the memory 512, the processor 510 may execute the program instructions.

The memory 512 and the data storage 504 may include computer-readable storage media for carrying or having computer-executable instructions or data structures stored thereon. Such computer-readable storage media may include any available media that may be accessed by a general-purpose or special-purpose computer, such as the processor 510. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may also be included within the scope of computer-readable storage media. Computer-executable instructions may include, for example, instructions and data configured to cause the processor 510 to perform a certain operation or group of operations.

The communication unit 514 may include one or more pieces of hardware configured to receive and send communications. In some embodiments, the communication unit 514 may include one or more of an antenna, a wired port, and modulation/demodulation hardware, among other communication hardware devices. In particular, the communication unit 514 may be configured to receive a communication from outside the computer system 500 and to present the communication to the processor 510 or to send a communication from the processor 510 to another device or network (e.g., the network 120 of FIG. 1).

The user interface device 516 may include one or more pieces of hardware configured to receive input from and/or provide output to a user. In some embodiments, the user interface device 516 may include one or more of a speaker, a microphone, a display, a keyboard, a touch screen, or a holographic projection, among other hardware devices.

The system modules 505 may include program instructions stored in the data storage 504. The processor 510 may be configured to load the system modules 505 into the memory 512 and execute the system modules 505. Alternatively, the processor 510 may execute the system modules 505 line-by-line from the data storage 504 without loading them into the memory 512. When executing the system modules 505, the processor 510 may be configured to perform one or more processes or operations described elsewhere in this disclosure.

Modifications, additions, or omissions may be made to the computer system 500 without departing from the scope of the present disclosure. For example, in some embodiments, the computer system 500 may not include the user interface device 516. In some embodiments, the different components of the computer system 500 may be physically separate and may be communicatively coupled via any suitable mechanism. For example, the data storage 504 may be part of a storage device that is separate from a device, which includes the processor 510, the memory 512, and the communication unit 514, that is communicatively coupled to the storage device. The embodiments described herein may include the use of a special-purpose or general-purpose computer including various computer hardware or software modules, as discussed in greater detail below.

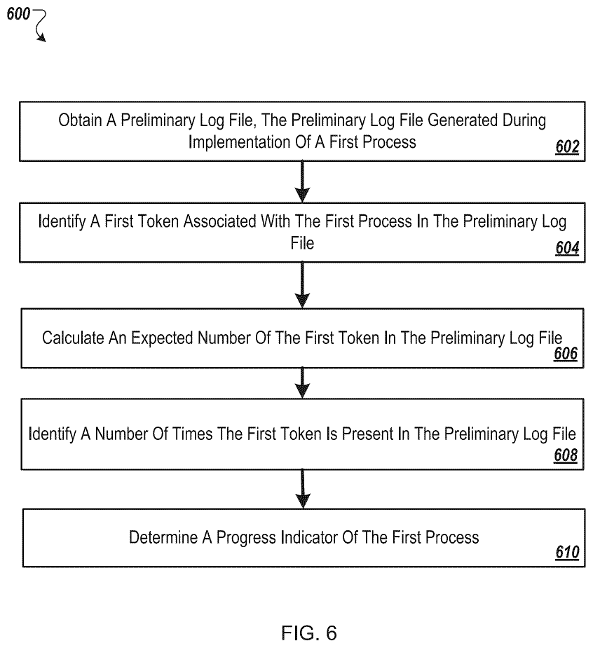

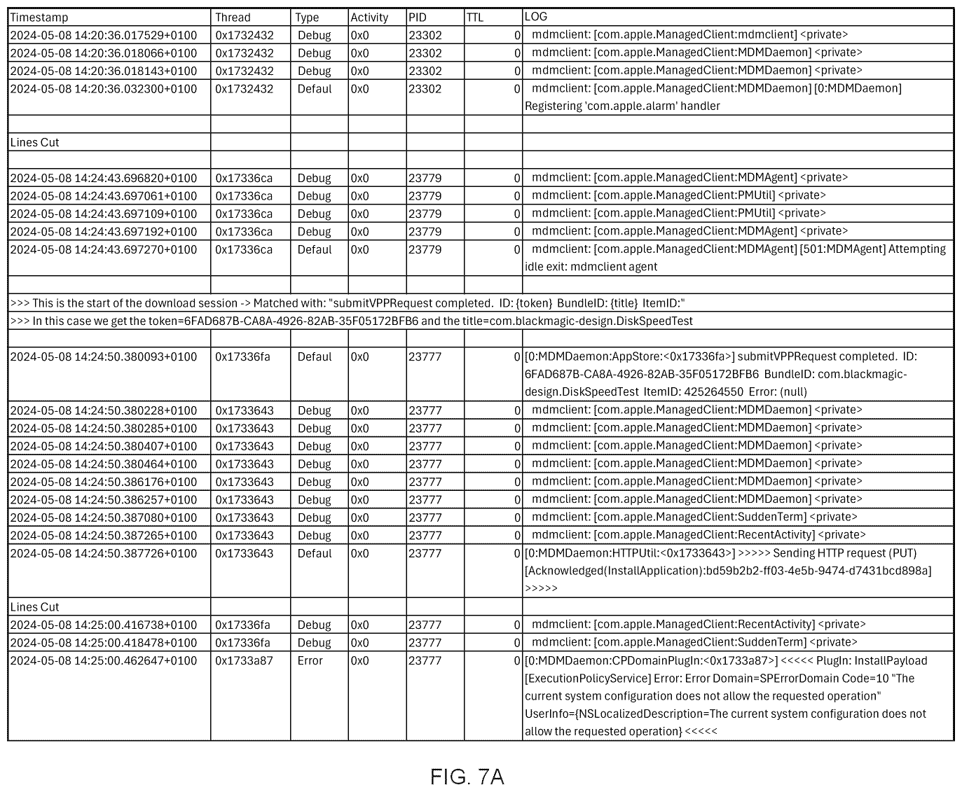

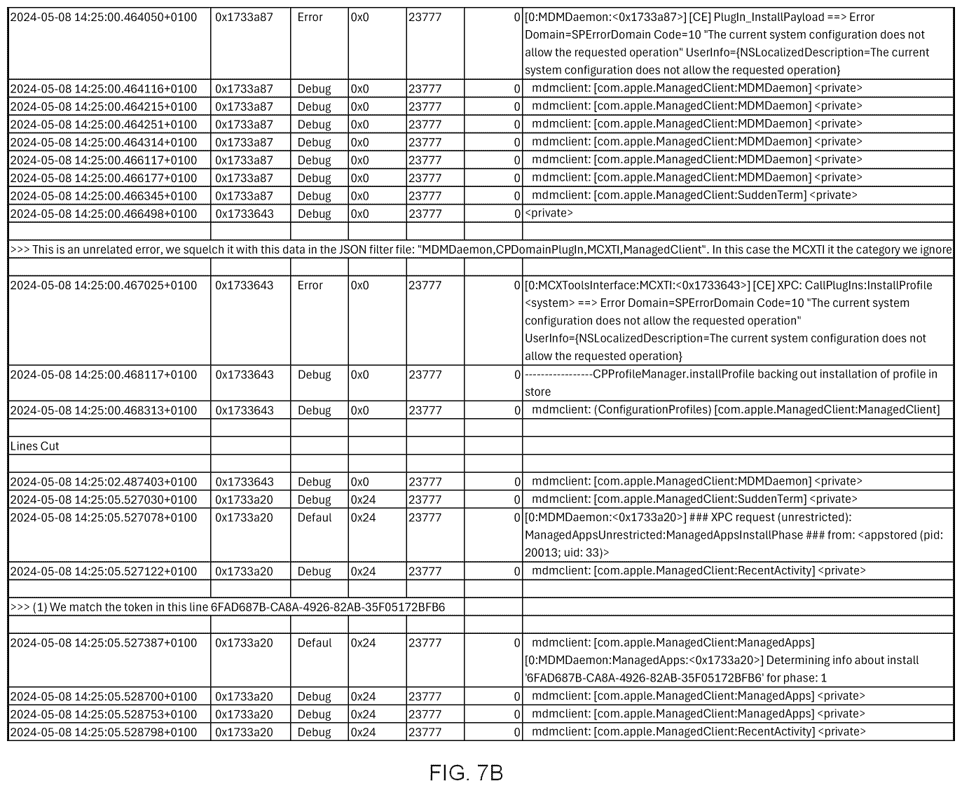

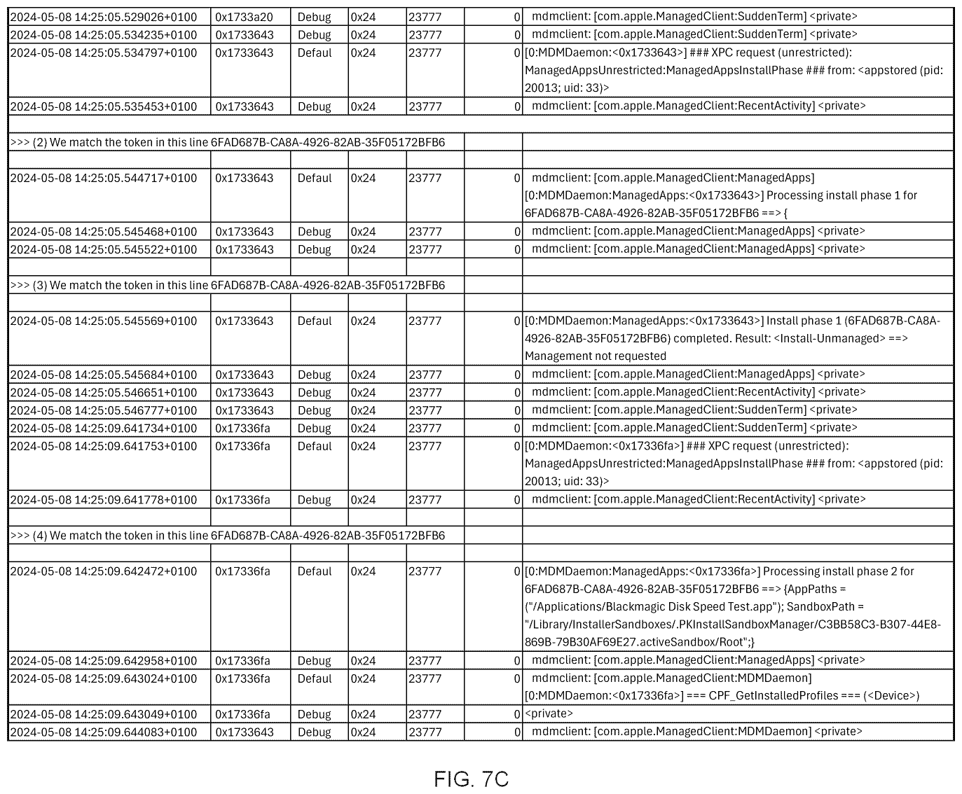

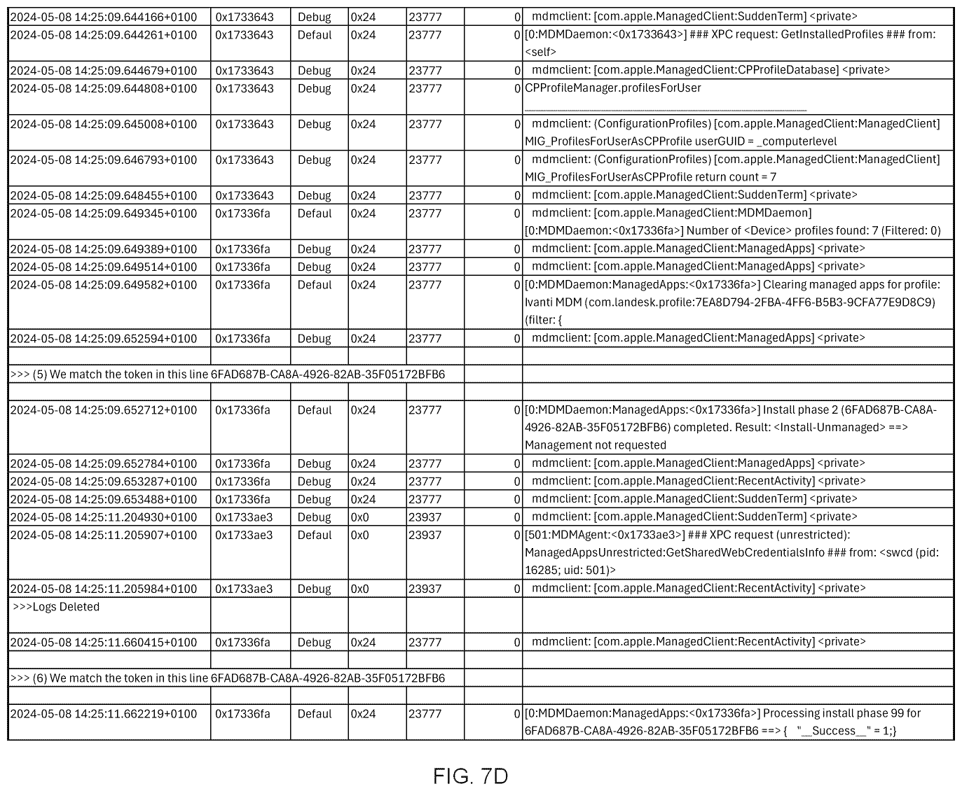

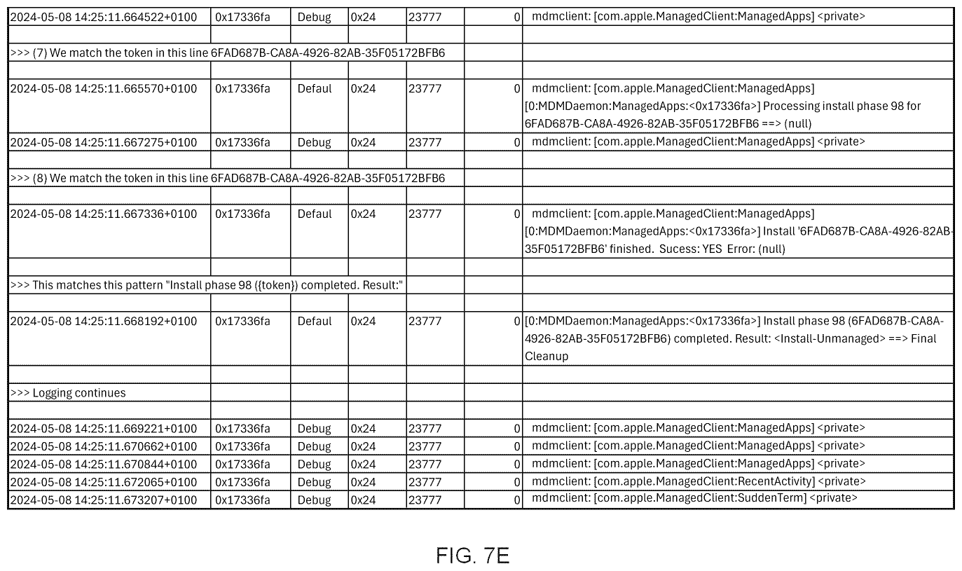

FIG. 6 is a flow chart of an example method 600 of process analysis, according to at least one embodiment of the present disclosure. The method 600 may be performed by a monitoring module such as the monitoring module 105 described elsewhere in the present disclosure. The method 600 may begin at block 602 in which a preliminary log file is obtained. For example, a log file may include an example log file of FIGS. 7A-7E. The preliminary log file may be generated during implementation of a first process. For example, the first process may include an installation or an update of an application at one or more devices and/or endpoints managed by an MDM platform. In some embodiments, the MDM platform may initiate processes to be performed at the managed devices. In some embodiments, although the MDM platform may initiate the processes, the processes may be performed by a third-party system. For example, in some embodiments, the managed devices include Apple™ devices or may include devices implementing one or more Apple products or operating systems. In such instances, the processes may be installed and/or updated by Apple or Apple operating systems. In these and other embodiments, a monitoring module associated with the MDM platform may obtain the preliminary log file of the processes in real time as the processes are running.

At block 604, a first token associated with the first process may be identified in the preliminary log file. In some embodiments, the first token may include a part of the preliminary log file that may be used to track progress of the log and/or the process associated with the log. In some embodiments, the first token may include one or more of a short bit of text or an icon that repeats in the preliminary log file. In some embodiments, the first token may represent a block including multiple log lines. For example, the block may include the multiple log lines associated with a particular task or operation that is part of the process. In such instances, a number of blocks present in the log may be determined based on a size of the log and a block size of the block. In some embodiments, the token may include multiple parts or sections. For example, in instances in which the first token includes a log line or multiple log lines, the token may have a prefix, contents, and a suffix. For example, the first token may start with the prefix, contain the contents, and end with the suffix. In these and other embodiments, presence of one of the prefix, the contents, or the suffix may represent presence of the first token. In the example of FIGS. 7A-7E, the token includes “6FAD687B-CA8A-4926-82AB-35F05172BFB6.”

In some embodiments, the first token may be identified based on previous runs of the first process. For example, the first process may have run with respect to different managed device. In such instances, the first token may be identified from previous successful runs. Additionally or alternatively, the monitoring module may obtain an expected log file of a successful installation or update from the third-party system. The monitoring module may identify the first token from the expected log file to track progress of the first process. For example, in the example of FIGS. 7A-7E, the token (e.g., 6FAD687B-CA8A-4926-82AB-35F05172BFB6″) is identified at various times in the log. In instances in which such expected log files are not available, the monitoring module may extract and/or determine the first token from the preliminary log file. For example, the first process may be initially run with respect to a certain managed device. The log file of the initial run of the first process may be used as the expected log file, from which the first token may be identified. The first token identified from such initial run may be used to track and/or monitor the process for subsequent implementations of the first process at different managed devices.

In some embodiments, the expected log file may be determined based on the source code associated with the first process. For example, in some instances, the monitoring module and/or the MDM platform (e.g., the MDM platform 102 of FIG. 1) may communicate with the third-party system (e.g., the third-party system 124 of FIG. 1) providing the first process to obtain the source code. The source code may provide expected log lines, from which the first token may be identified.

At block 606, an expected number of the first token in the preliminary log file may be calculated. In some instances, in which the first token is a fixed token or a fixed string, a number of the fixed string in the preliminary log file may be determined. In some instances, in which the first token includes a block or multiple lines, the expected number of the first token may be determined based on a total size of the preliminary log file and a block size. For example, the first process may be expected to have 300 lines (e.g., the total size) in the log. The 300 lines may be divided into 10-line blocks (e.g., the block size) that each start with a particular text. In these and other embodiments, the first token may include the 10-line blocks. The expected number of the first token may be determined by dividing the total size by the block size which, in the current example, is 30. With reference to FIGS. 7A-7E, the token is identified eight times. In some embodiments, only the log lines of interest may be counted toward to the total size of the log or of the blocks. The log lines of interest may include log lines that match the patterns of the first token. For example, the first token may include a pattern (e.g., prefix, suffix, contents, etc.), in which the log lines of interest may include log lines that are associated with at least part of the pattern. In these and other embodiments, the log lines not associated with the first token (e.g., the error lines) may not be counted toward the total size of the log.

In some embodiments, the expected number of the first token in the preliminary log file may be determined based on previous runs of the first process and/or the expected preliminary log file. For example, the first token may be expected to be present in the preliminary log file a certain number of times (e.g., 30 times). For instance, the preliminary log file may be expected to have 30 instances of at least a part of the token (e.g., fixed token, prefix, content, suffix, etc.).

Additionally or alternatively, the content of the preliminary log file may be observed and/or monitored to identify log lines related to size and/or progress of the first token. For example, the first token may be associated with a certain file (e.g., the first token is the file name of a certain file). A log line may recite: “Total file size of <token> is y bytes” and subsequent log lines may include log lines that recite “Downloaded z bytes of <token>.” The “z” bytes in the log lines may be compared against the “y” bytes of the <token> to monitor progress of the first process.

At block 608, a number of times the first token is present in the preliminary log file may be identified. For example, the as the log file progresses, the presence of the first token may be counted.

At block 610, a progress indicator of the first process may be determined. The progress indicator may be based on a comparison between the expected number of the first token in the preliminary log file and the number of times the first token is present in the preliminary log file. For example, the counted or actual number of the first token may be compared to the expected number of the first token to determine where in the first process the progress is in. For example, in instance in which there are 30 expected number of tokens and counted tokens are at 10, the progress indicator may be around 33% (e.g., 10/30).

With reference to FIGS. 7A-7E, the token is identified eight times. After the first instance, which is indicated in FIG. 7B by “>>>(1) We match the token in this line . . . “, the token is identified. At this point, it may be determined that one-eighth of the process has occurred. At the second instance, which is indicated in FIG. 7C by “>>> (2) We match the token in this line . . . “, it may be determined that one-quarter (e.g., 2/8) of the process has occurred. This may be continued as the token is matched throughout the log.

The method 600 may be performed by the remote management device 104 described elsewhere in the present disclosure or by another suitable computing system, such as the computer system 500 of FIG. 5. In some embodiments, the remote management device 104 or the other computing system may include or may be communicatively coupled to a non-transitory computer-readable medium (e.g., the memory 512 of FIG. 5) having stored thereon programming code or instructions that are executable by one or more processors (such as the processor 510 of FIG. 5) to cause a computing system or the remote management device 104 to perform or control performance of the method 600. Additionally or alternatively, the remote management device 104 may include the processor 510 that is configured to execute computer instructions to cause the remote management device 104 or other computing systems to perform or control performance of the method 600. The remote management device 104 or the computer system 500 implementing the method 600 may be included in a cloud-based managed network, an on-premises system, or another suitable network computing environment. Although illustrated as discrete blocks, one or more blocks in FIG. 6 may be divided into additional blocks, combined into fewer blocks, or eliminated, depending on the desired implementation.

For example, the method 600 may include determining that the first process failed to complete. For example, the first process may finish without the counted number of the first token reaching the expected number of the first token. As another example, the first process may not finish and provide an error message. In these and other embodiments, it may be determined that an error has occurred with respect to the first process.

In some embodiments, a location of the error may be identified. For example, in instance in which the token was present 55 times out of 100, the error may be located between the location of the 55^{th} token and expected location of the 56^{th} token within the log. In some embodiments, the method 600 may further include identifying one or more lines in the log including the error with respect to the first process. For example, one or more lines that ended unsuccessfully and/or include an error message may be identified. In instances in which such lines may not be identified, one or more lines between the successful token (e.g., the 55^{th} token) and the unsuccessful token (e.g., the 56^{th} token) may be identified as the one or more lines having the error.

In some embodiments, the method 600 may further include determining that the number of times the first token is present matches the expected number of the first token. For instance, the first process may come to completion as expected based on the first token. In such instances, a status of the first process may be reset as completed and duration of the first process may be recorded.

In some embodiments, the duration of the first process may be determined based on a start time and a stop time of the first process. For example, the method 600 may include identifying the start time of the first process and the stop time of the first process. In some embodiments, the start time may correspond to a time the preliminary log file is first obtained. In other embodiments, the start time may correspond to a time the first token is first located in the preliminary log file. In some embodiments, the stop time may correspond to a time the last token (e.g., 100^{th} token out of 100) is detected in the preliminary log file. The processing time may be the time between the start time and the stop time. In some embodiments, the processing time may be compared with an expected processing time of the process. The expected processing time may be determined based on prior runs of the process and/or be obtained from the third-party system.

The embodiments described herein may include the use of a special purpose or general-purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data, which cause a general-purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

The various features illustrated in the drawings may not be drawn to scale. The illustrations presented in the present disclosure are not meant to be actual views of any particular apparatus (e.g., device, system, etc.) or method, but are representations employed to describe embodiments of the disclosure. Accordingly, the dimensions of the features may be expanded or reduced for clarity. In addition, some of the drawings may be simplified for clarity. Thus, the drawings may not depict all of the components of a given apparatus (e.g., device) or all operations of a particular method.

Terms used in the present disclosure and the claims (e.g., bodies of the appended claims) are intended as “open” terms (e.g., the term “including” should be interpreted as “including, but not limited to,” the term “having” should be interpreted as “having at least,” the term “includes” should be interpreted as “includes, but is not limited to,” among others). Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in instances in which a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Further, any disjunctive word or phrase presenting two or more alternative terms should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

The terms “first,” “second,” “third,” etc., are not necessarily used to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although embodiments of the present inventions have been described in detail, it should be understood that the various changes, substitutions, and alterations could be made hereto without departing from the scope of the invention.

What is claimed is:

1. A method of process analysis, the method comprising:
obtaining a preliminary log file, the preliminary log file generated during implementation of a first process;
identifying a first token associated with the first process in the preliminary log file;
calculating an expected number of the first token in the preliminary log file;
identifying a number of times the first token is present in the preliminary log file; and
determining a progress indicator of the first process based on a comparison between the expected number of the first token in the preliminary log file and the number of times the first token is present in the preliminary log file.

2. The method of claim 1, wherein the first token includes one or more of a short bit of text or an icon.

3. The method of claim 1, wherein:
the first token represents a block including a plurality of log lines; and
calculating the expected number of the first token in the preliminary log file comprises:
identifying a size of at least a part of the preliminary log file associated with the first token;
identifying a block size of the block, wherein the block size includes a particular number of log lines; and
determining a number of blocks corresponding to the expected number of the first token, based on the size of at least part of the preliminary log file and the block size.

4. The method of claim 3, wherein:
the determining the progress indicator is further based on the block size; and
the determining the progress indicator includes filtering one or more log lines that do not conform to a log pattern to exclude error log lines and fatal error log lines that do not contribute to the identified block size.

5. The method of claim 1, further comprising:
determining that the first process failed to complete;
determining that an error has occurred with respect to the first process;
identifying a location of the error;
identifying one or more lines having the error with respect to the first process; and
generating a list of the one or more lines,
wherein the location of the error is determined using a location of last detected first token.

6. The method of claim 1, further comprising:
determining that the number of times the first token is present matches the expected number of the first token;
resetting a status the first process as completed; and
recording duration of the first process.

7. The method of claim 1, further comprising:
identifying a start time of the first process;
identifying a stop time of the first process; and
determining processing time of the first process based on the start time and the stop time; and
comparing the processing time of the first process to an expected time of the first process.

8. The method of claim 7, wherein the start time corresponds to a time a first log line is identified, the first log line identified using a log pattern associated with the first process.

9. The method of claim 8, wherein the log pattern includes one or more of a prefix, a suffix, or contents.

10. The method of claim 1, wherein determining the progress indicator of the first process comprises:
identifying a first instance of the first token in the preliminary log file, the first instance representing start of the first process;
identifying additional instances of the first token in the preliminary log file;
progressing the progress indicator with each additional instance of the first token; and
identifying a last expected instance of the first token, the last expected instance of the first token representing completion of the first process, wherein the last expected instance of the first token is determined based on the expected number of the first token in the preliminary log file.

11. A non-transitory computer-readable medium having encoded therein programming code executable by one or more processors to perform or control performance of operations for process analysis, the operations comprising:
obtaining a preliminary log file, the preliminary log file generated during implementation of a first process;
identifying a first token associated with the first process in the preliminary log file;
calculating an expected number of the first token in the preliminary log file;
identifying a number of times the first token is present in the preliminary log file; and
determining a progress indicator of the first process based on a comparison between the expected number of the first token in the preliminary log file and the number of times the first token is present in the preliminary log file.

12. The non-transitory computer-readable medium of claim 11, wherein the first token includes one or more of a short bit of text or an icon.

13. The non-transitory computer-readable medium of claim 11, wherein:
the first token represents a block including a plurality of log lines; and
calculating the expected number of the first token in the preliminary log file comprises:
identifying a size of at least a part of the preliminary log file associated with the first token;
identifying a block size of the block, wherein the block size includes a particular number of log lines; and
determining a number of blocks corresponding to the expected number of the first token, based on the size of at least part of the preliminary log file and the block size.

14. The non-transitory computer-readable medium of claim 13, wherein:
the determining the progress indicator is further based on the block size; and
the determining the progress indicator includes filtering one or more log lines that do not conform to a log pattern to exclude error log lines and fatal error log lines that do not contribute to the identified block size.

15. The non-transitory computer-readable medium of claim 11, wherein the operations further comprise:
determining that the first process failed to complete;
determining that an error has occurred with respect to the first process;
identifying a location of the error;
identifying one or more lines having the error with respect to the first process; and
generating a list of the one or more lines,
wherein the location of the error is determined using a location of last detected first token.

16. The non-transitory computer-readable medium of claim 11, wherein the operations further comprise:
determining that the number of times the first token is present matches the expected number of the first token;
resetting a status the first process as completed; and
recording duration of the first process.

17. The non-transitory computer-readable medium of claim 11, wherein the operations further comprise:
identifying a start time of the first process;
identifying a stop time of the first process; and
determining processing time of the first process based on the start time and the stop time; and
comparing the processing time of the first process to an expected time of the first process.

18. The non-transitory computer-readable medium of claim 17, wherein the start time corresponds to a time a first log line is identified, the first log line identified using a log pattern associated with the first process.

19. The non-transitory computer-readable medium of claim 18, wherein the log pattern includes one or more of a prefix, a suffix, or contents.

20. The non-transitory computer-readable medium of claim 11, wherein determining the progress indicator of the first process comprises:
identifying a first instance of the first token in the preliminary log file, the first instance representing start of the first process;
identifying additional instances of the first token in the preliminary log file;
progressing the progress indicator with each additional instance of the first token; and
identifying a last expected instance of the first token, the last expected instance of the first token representing completion of the first process, wherein the last expected instance of the first token is determined based on the expected number of the first token in the preliminary log file.
